(19) United States
(12) Patent Application Publication
(10) Pub. No.: US 2022/0327516 A1
(43) Pub. Date: Oct. 13, 2022

(54) Online Payment Method for Vending Machines

(71) Applicant: Daniel Lin, San Francisco, CA (US)

(72) Inventor: Daniel Lin, San Francisco, CA (US)

(21) Appl. No.: 17/229,826

(22) Filed: Apr. 13, 2021

(51) Int. Cl. G06Q 20/32; G06Q 20/18

(52) U.S. Cl. CPC G06Q 20/3278; G06Q 20/18; G06Q 20/3276

(57) ABSTRACT

Systems and methods for conducting a payment transaction at a vending machine using a mobile device are disclosed herein. A vending machine includes a Bluetooth Low Energy (BLE) module that is used to connect to a user's mobile device. The mobile device's web browser accesses a web page that establishes a BLE connection between the vending machine and mobile device and also facilitates a payment transaction with an online payment service provider without transmitting any payment information to the vending machine.

### BACKGROUND

Today's self-service or unattended payment kiosks, such as vending machines, support a number of payment modalities (“vending machines” herein may be used generally to describe any unattended payment kiosks that vends or dispenses an item or service). In addition to traditional cash (bill and coin) acceptors, vending machines typically include a variety of cashless payment readers to accommodate magnetic stripe, EMV chip and contactless NFC payments. Customers can either swipe, dip or tap their payment cards (e.g., credit or debit, etc.) or digital wallets like Google Pay, Samsung Pay or Apple Pay using their smart phones.

All of these payment options, however, require a customer to transmit sensitive payment information (e.g., credit card information, etc.) to the payment readers in the vending machine. Payment readers typically encrypt the payment data and send it to a hardware telemetry module inside the kiosk. The telemetry module establishes a connection, either through a cellular network or a local area network (LAN), to a remote payment gateway. In turn, the payment gateway transmits the payment data to a credit card processor which clears the payment transaction. Upon clearing the transaction, the credit card processor sends a signal back to the payment gateway which in turn sends a signal to the vending machine to complete the transaction (e.g., vend a purchased item, etc.).

Current costs for cashless readers and telemetry hardware can be significant. Additionally, payment gateway providers typically charge a monthly fee for every deployed vending machine. The credit card processor also charges a percentage fee (typically single digits) for each payment transaction. These costs, particularly the cashless readers, telemetry module, and payment gateway fees, make inexpensive vending machines cost prohibitive and therefore limit the ability to provide unattended vending in environments where cheaper vending solutions may be desirable.

Rather than invest in expensive cashless readers, some vending machine businesses opt for displaying an inexpensive QR code on the vending machine to initiate payment transactions. The customer scans the QR code into a smart phone which launches a payment application that the customer previously installed on the phone. The payment application facilitates a payment transaction and upon completion of the payment, interacts with a backend server (e.g., such as a payment gateway or other vending machine server) which then communicates with the vending machine through its telemetry module to confirm the payment. The vending machine is then able to dispense the purchased item. However, the requirement of a pre-installed custom application on a customer's phone reduces the situations where such a payment flow is feasible. For example, one time encounters of vending machines would not provide proper incentive for a customer to download and install a mobile application. Additionally, other hardware and software costs such as the telemetry module and the backend services used to consummate a QR code initiated payment transaction continue to make low-cost vending machines cost prohibitive.

### SUMMARY

Systems and methods for conducting a payment transaction at a vending machine using a mobile device are disclosed herein. In certain embodiments, the vending machines do not need to include a card or other cashless reader or telemetry module to interact with payment gateways, thereby enabling the creation of lower-cost vending machines. Instead, a mobile device of a user initiates and completes a payment transaction by communicating with an online payment service, such as PayPal, Google Pay, Apply Pay and the like. In this manner, no payment information needs to be exchanged between the mobile device and the vending machine.

In one embodiment, a mobile device receives from the vending machine a link for a web site. The vending machine may provide the link by displaying a QR code or mounting an NFC tag to be scanned by the mobile device. The vending machine also includes a Bluetooth Low Energy (BLE) module to communicate with the mobile device. Upon user interaction with the web site on the mobile device, a BLE connection is established between the vending machine and the mobile device. The user on the mobile device initiates, through the web site, a payment transaction utilizing an online payment service and subsequently receives, through the web site, confirmation from the online payment service of the payment transaction. Upon confirmation of the payment transaction, the mobile device transmits, based on instructions from the web site, a signal through the BLE connection to the vending machine to vend a purchased product and the vending machine accordingly dispenses the purchased product.

One embodiment of a system in accordance with the invention would comprise a vending machine with a BLE module configured to receive signals from mobile devices to dispense product and a web server configured to serve a web site to a mobile device of a user intending to purchase a product at the vending machine. The web site would be programmed to (i) establish a BLE connection between the mobile device and the vending machine, (ii) initiate a payment transaction with an online payment service, and (iii) upon confirmation of a successful payment, transmit a signal through the BLE connection to the vending machine to dispense a purchased product.

### BRIEF DESCRIPTION OF THE DRAWINGS

FIG. 1 depicts an environment in which an embodiment of the invention can be deployed.

FIG. 2 depicts a flow chart for conducting a payment transaction at a vending machine in accordance with one embodiment of the invention.

FIGS. 3A-3C depict pages of a web site in accordance with one embodiment of the invention.

### DETAILED DESCRIPTION

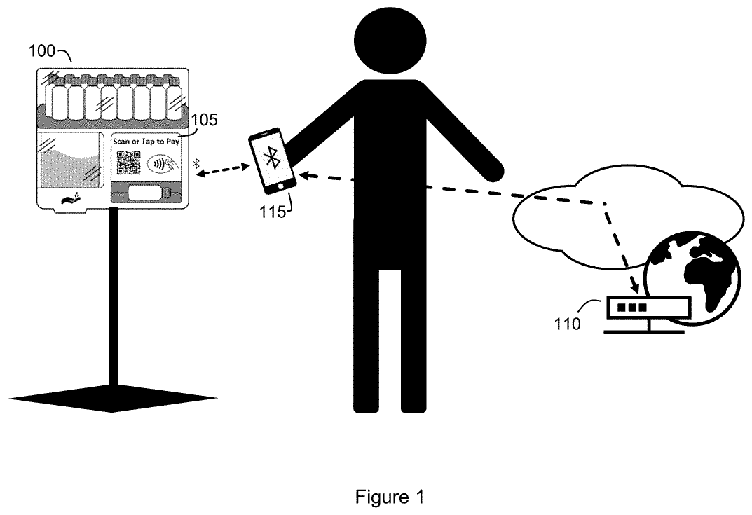

FIG. 1 depicts a particular environment in which an embodiment of the invention can be deployed. A vending machine 100 is located at a premises where vending a particular item or items is desirable. In certain embodiments, vending machine 100 may be a lower-cost device that has a smaller and simpler form factor than traditional vending machines (although it should be recognized that the teachings herein can also be used with traditional vending machines). For example, certain embodiments of vending machine 100 may not have the more expensive cashless or card readers (e.g., magnetic stripe, EMV chip and contactless NFC) and telemetry modules that more traditional vending machines include to interact with payment gateways to receive and process payments from users. One example of a vending machine 100 that could be used in accordance with the invention herein is depicted in FIG. 1 and is an embodiment of dual dispensing hand sanitizer kiosk described in U.S. patent Ser. No. 9,761,079 (hereby incorporated by reference), which only vends a single type of item, such as hand sanitizer, in single use form as well as packaged form (e.g., bottles). As depicted, the embodiment of vending machine 100 of FIG. 1 vends hand sanitizer bottles while also providing a courtesy free portion hand sanitizer gel or foam. Such a vending machine could be placed in locations where hand sanitizers are desirable (e.g., office lobbies, gyms, public shopping walkways, etc.) but where more traditional larger and vending machines are too costly, complicated, and take too much space. Vending machine 100 includes a Bluetooth Low Energy (BLE) module, such as a HM-10, AT-09, or RN4870 module or any other available Bluetooth or BLE module. The BLE module may be coupled to a microcontroller which may also control a motorized or other dispensing mechanism of vending machine 100. In certain embodiments, vending machine 100 may also display a QR code or mount an NFC tag 105 that can be quickly scanned to provide a link or URL to a web site that is served by a remote web server 110. A user desiring to make a purchase at vending machine 100 can use his or her mobile device 115 to conduct a purchase transaction by interacting with the web site served by remote web server 110 as well as with vending machine 100 through the BLE module in the vending machine.

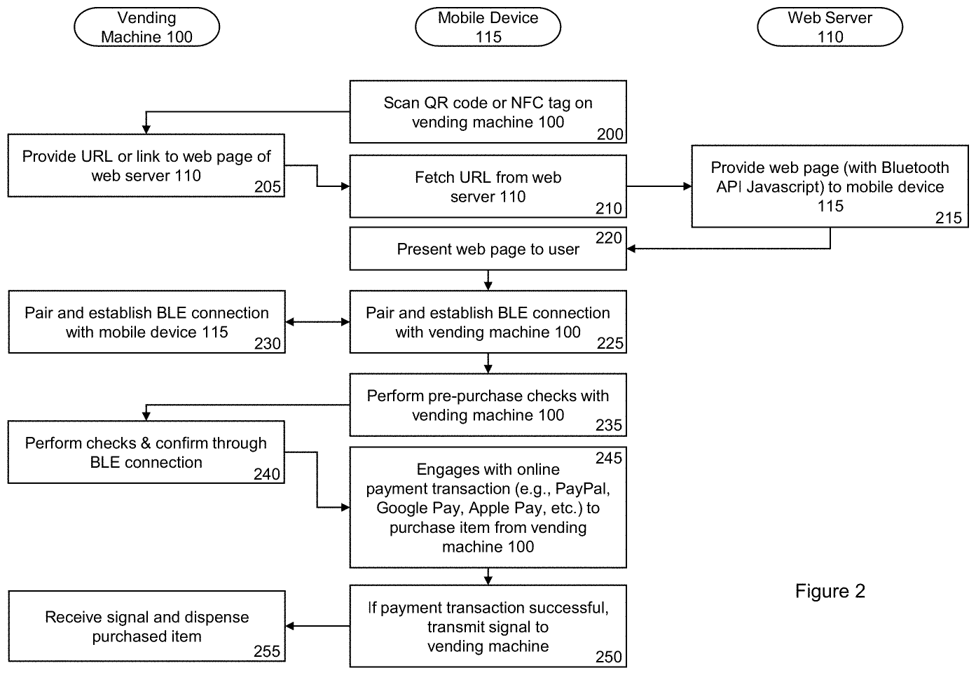

FIG. 2 depicts a flow chart for conducting a payment transaction at a vending machine in accordance with one embodiment of the invention. In step 200, the user uses mobile device 115 to scan the QR code or NFC tag on vending machine 100. In step 205, the QR code or NFC tag provides a URL or link to a web page served by remote web server 110 and, in step 210, mobile device 115 fetches the URL or link from remote web server 110 and presents the web page in its browser to display in step 220. The presented web page requests that the user connect to vending machine 100 to conduct a payment transaction, for example, by pressing a “Connect” button on the web page. In certain embodiments, the web page (or pages) presented by the URL (or subsequently navigated to by the user interacting with the web page) includes JavaScript or a similar web page scripting language to discover and communicate with Bluetooth devices using the Web Bluetooth API being developed by the W3 Web Bluetooth Community Group (see, e.g., https://webbluetoothcg.github.io/web-bluetooth/, which is hereby incorporated by reference). By utilizing the Web Bluetooth API and providing web pages with JavaScript that can invoke the Bluetooth functionalities of mobile device 115 through a mobile web browser, embodiments need not provide or install any specific mobile application in order to engage in communication with vending machine 100.

Upon a user request through the web page to connect to vending machine 100, mobile device 115, through its Web Bluetooth API supported web browser, displays the name of vending machine 100 and requests the user to confirm pairing mobile device 115 with vending machine 100. In steps 225 and 230, mobile device 115 initiates a pairing with vending machine 100 and, upon successful pairing, further initiates a BLE connection with vending machine 110. In step 235, once a BLE connection is established, mobile device 115, through the JavaScript code in the web page, communicates with vending machine 100 to perform a number of checks, such as, but not limited to, whether the vending machine (i) has sufficient power to dispense a product (e.g., if battery powered), (ii) has sufficient inventory of goods to dispense, or (iii) has the desired type of good to dispense. If the checks are confirmed in step 240, the user engages in an online payment transaction through the web page on mobile device 115 in step 245. For example, the web page may present a pay button (or multiple pay buttons) or similar widget from one or more online payment service providers such as, but not limited to, Google Pay, PayPal, and Apple Pay. In this manner, the payment transaction is conducted through the web page on mobile device 115 (e.g., communicating with the online payment service provider through the WiFi or cellular Internet connection on mobile device 115) and, unlike traditional vending machines, no payment information is conveyed to the vending machine. In step 250, if the payment transaction with the online payment service provider is successful, then mobile device 115, through the web page, transmits a signal to vending machine 100 through the BLE connection to dispense the purchased item, and in step 255, vending machine 100 dispenses the item to the user. In certain embodiments, the communication through the BLE connection between vending machine 100 and 115 is encrypted.

In certain embodiments, a custom service, in accordance with the protocol specified by Bluetooth GATT (Generic Attribute Profile), in the BLE module of vending machine 100 facilitates communications with mobile device 115. For example, one or more characteristics associated with the custom service may be used to exchange data between mobile device 115 and vending machine 100. In one embodiment, mobile device 115 may read data from and also write data to the same characteristic of the custom service. Mobile device 115, in accordance with JavaScript code running on the web page (or pages) presented in step 220, may send requests such as the pre-purchase checks (e.g., inventory, power, item type, etc.) in step 235 or the request to dispense in step 250 by writing specific requests to the same characteristic through the established BLE connection. Mobile device 115, may then wait to be notified of a response from the BLE module of vending machine 100 in accordance with Bluetooth GATT. When the BLE module receives the request from mobile device 115, a microcontroller coupled to the BLE module may read the characteristic that was written by mobile device 115 and process the request accordingly (e.g., respond with inventory or power status or dispense a product, etc.) and write back to the BLE module a response (e.g., confirmation of inventory, power or acknowledge of a successful dispensing of product, etc.). In turn, the BLE module may then notify mobile device 115 of the response through the established BLE connection. In alternative embodiments, multiple characteristics may be used to perform similar tasks. For example, in another embodiment, mobile device 115 may read a specific inventory characteristic, power characteristic (which may be part of a standard Bluetooth service rather than a custom service) or other characteristic to obtain information on the status of vending machine 100, rather than sending a specific request to the BLE module and then waiting to be notified of a response. Similar, a separate characteristic for receiving a dispense command may be written to in order request vending machine 100 dispense a purchased item.

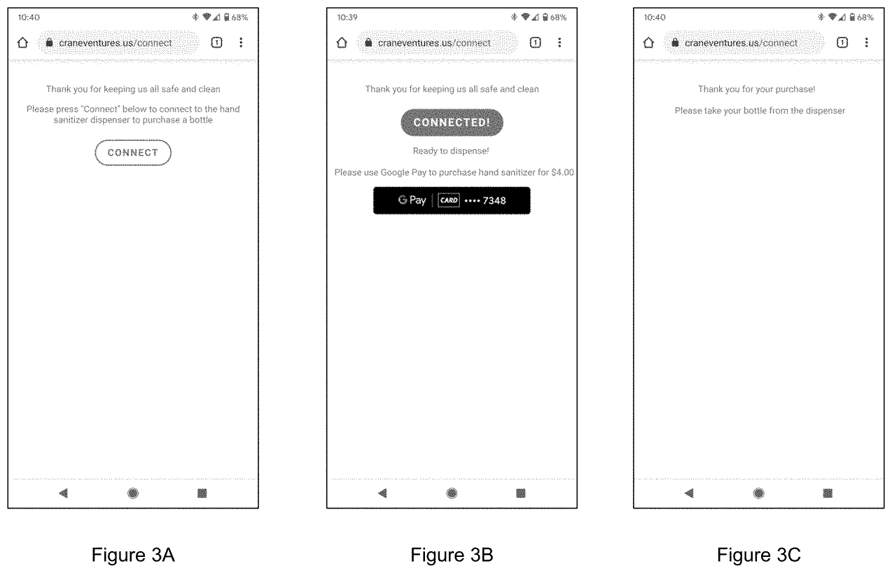

FIGS. 3A-3C depict pages of a web site in accordance with one embodiment of the invention. For example, FIG. 3A is one example of a web page that might be presented to a user in a web browser on mobile device 115 when he or she scans the QR code or NFC tag in step 200. FIG. 3B is one example of a web page that might appear on mobile device after steps 225 to 240, when mobile device 115 has successfully connected to vending machine 100 and has confirmed an ability to dispense an item, if purchased. FIG. 3C is one example of a web page that might be presented on mobile device in step 115 in step 235, after a successful online payment transaction with an online payment service provider (e.g., Google Pay in the embodiment of FIG. 3B) and a successful signal to vending machine 100 to dispense a purchased product in step 255.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. For example, although embodiments here are described as having QR codes or NFC tags that provide a URL to a web page, in alternative embodiments, vending machine 100 may instruct the user to immediately establish a BLE connection through mobile device 115, which, upon establishment of a BLE connection provides the URL to mobile device 100. In yet another embodiment, the BLE module in vending machine 100, upon such a successful BLE connection, may provide the web page (or pages) including the JavaScript code implementing the Bluetooth APIs to mobile device 115 directly. In yet other alternative embodiments, rather than utilizing BLE as the connecting technology between mobile device 115 and vending machine 100, classic Bluetooth (or other non-BLE versions thereof) or active NFC technologies may be used to establish a communication channel therebetween.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

I claim:

1. A method for conducting a payment transaction at a vending machine using a mobile device, the method comprising the steps of:
receiving, from the vending machine, a link for a web site by the mobile device, wherein the vending machine (i) provides the link by displaying a QR code or mounting an NFC tag to be scanned by the mobile device, and (ii) comprises a Bluetooth Low Energy (BLE) module to communicate with the mobile device;
upon user interaction with the web site on the mobile device, establishing a BLE connection between the vending machine and the mobile device;
initiating, through the web site, a payment transaction utilizing an online payment service;
receiving, at the web site, confirmation from the online payment service of the payment transaction;
upon confirmation of the payment transaction, transmitting by the mobile device, based on instructions from the web site, a signal through the BLE connection to the vending machine to vend a purchased product, wherein the vending machine dispenses the purchased product.

2. The method of claim 1 further comprising receiving confirmation from the vending machine through the BLE connection of inventory in the vending machine.

3. The method of claim 1, further comprising receiving confirmation through the BLE connection of sufficient power in the vending machine to vend a product.

4. The method of claim 1, wherein no payment information is shared between the vending machine and the mobile device through the BLE connection.

5. The method of claim 4, wherein no mobile application for making purchases at the vending machine is installed on the mobile device.

6. The method of claim 1, wherein the web site presents at least one of PayPal, Google Pay or Apple Pay as an option for the online payment service.

7. A method for conducting a payment transaction at a vending machine using a mobile device, the method comprising the steps of:
providing, by the vending machine, a URL for a web site to the mobile device, wherein the vending machine includes a Bluetooth Low Energy (BLE) module;
upon user interaction with the web site on the mobile device, establishing a connection between the vending machine and the mobile device through the BLE module;
receiving, at the vending machine, a signal from the mobile device to dispense a purchased product, wherein the signal is received by the vending machine after (i) a user initiates a payment transaction through the web page with an online payment service, (ii) confirmation of the payment transaction is received at the web site from the online payment service, and (iii) the signal is transmitted to the vending machine through the established connection; and
dispensing a purchased product from the vending machine.

8. The method of claim 7, wherein the mobile device receives the URL by scanning a QR code or NFC tag on the vending machine.

9. The method of claim 7 further comprising transmitting, by the vending machine, confirmation of sufficient inventory to dispense the purchased product.

10. The method of claim 7, wherein no payment information is shared between the vending machine and the mobile device through the connection.

11. The method of claim 7, wherein the communication between the vending machine and the mobile device through the connection is encrypted.

12. The method of claim 7, no mobile application for completing a vending machine purchase transaction is installed on the mobile device.

13. The method of claim 7, wherein the vending machine does not include a credit card reader.

14. A system for conducting a payment transaction at a vending machine using a mobile device, the system comprising:
a vending machine comprising a Bluetooth Low Energy (BLE) module configured to receive signals from mobile devices to dispense product; and
a web server configured to serve a web site to a mobile device of a user intending to purchase a product at the vending machine, wherein the web site is programmed to (i) establish a BLE connection between the mobile device and the vending machine, (ii) initiate a payment transaction with an online payment service, and (iii) upon confirmation of a successful payment, transmit a signal through the BLE connection to the vending machine to dispense a purchased product.

15. The system of claim 14, wherein the BLE module is coupled to a microprocessor that controls a dispensing mechanism of the vending machine.

16. The system of claim 14, wherein the vending machine further displays a QR code or NFC tag that includes a URL to the web site that can be scanned by the mobile device.

17. The system of claim 14, wherein the web site is further programmed to request inventory and battery checks from the vending machine through the BLE connection.

18. The system of claim 14, wherein the vending machine does not include a telemetry module.

19. The system of claim 14, wherein no payment information is shared between the mobile device and the vending machine through the BLE connection.

20. The system of claim 14, wherein the web site utilizes JavaScript to access the Bluetooth capabilities of the mobile device.
